(19) United States
(12) Patent Application Publication
(10) Pub. No.: US 2019/0038072 A1
(43) Pub. Date: Feb. 7, 2019

(54) HEATED BEVERAGE RAIL

(71) Applicant: Food Warming Equipment Co., Crystal Lake, IL (US)

(72) Inventor: Deron S. Lichte, Crystal Lake, IL (US)

(21) Appl. No.: 15/668,069

(22) Filed: Aug. 3, 2017

(51) Int. Cl. A47J 36/24

(52) U.S. Cl. CPC A47J 36/2483

(57) ABSTRACT

A heated beverage rail comprises a shelf with a horizontal surface for receiving at least one beverage container, a front wall, a rear wall, and a pair of side walls extending vertically above the shelf, a top wall extending from a top edge of the front wall substantially parallel to the shelf and defining a space within the rail bounded by the top wall cup bracket, front wall, rear wall and side walls. At least one opening is provided in the top wall cup bracket, sized to receive a heated beverage cup. An electrical heating unit is arranged within the rail to heat the space below top wall cup bracket and all cup contact surfaces of the rail, and a thermostat is in line with the heating unit configured to control a temperature of the space below top wall cup bracket and all cup contact surfaces of the rail.

### BACKGROUND OF THE INVENTION

The present invention relates to heated rails in the form of a “speed rail” bar rack or shelving units designed to hold previously prepared portioned heated beverages.

In many food and beverage service operations such as restaurants and coffee shops, customers order their heated beverages in advance of arriving to pick up the ordered beverages, often via mobile application platforms. If the beverages are prepared before the customer arrives, the beverage may cool down to an undesirable service temperature before the beverage can be delivered to the customer if it is merely placed on an ambient counter awaiting the customer.

Food and beverage cabinets are known in which heating elements are used for heating the air and heating water to increase the temperature and humidity within the cabinet. Such an arrangement is shown, for example, in U.S. Pat. No. 8,176,844, assigned to the present applicant.

Other types of food and beverage cabinets are known for providing heat, without any humidity adjustment. Such an arrangement is shown, for example, in U.S. Pat. No. 4,194,109 which shows a raised heating element 53 on a shelf 55 designed to carry a food tray in a food transport unit that is mounted on wheels and contains a number of individual shelves for receiving food trays.

Most restaurants and coffee shops have limited space in the customer delivery or mobile order pick-up area, preventing the use of large cabinets and other similar heated storage units known in the art.

### SUMMARY OF THE INVENTION

In an embodiment of the invention, a heated beverage rail comprises a shelf with a horizontal surface for receiving at least one beverage container, a front wall extending vertically above the shelf, a rear wall extending vertically above the shelf, a pair of side walls extending vertically above the shelf, a top wall extending from a top edge of the front wall substantially parallel to the shelf and defining a space within the dispenser bounded by the top wall, front wall, rear wall and side walls. At least one opening is provided in the top wall sized to receive a heated beverage cup. An electrical heating unit is arranged within the heated rail to heat the contact surface of the bottom, front back of the cup/vessel, both the space below the top wall “cup bracket” and all cup contact surfaces, in addition to the emitted heat from the contact surface to the immediate air, that would have otherwise been lost, and a thermostat is in line with the heating unit configured to control a temperature of the rail cup contact surfaces. The rail has a low profile and small footprint, and can easily fit on a counter or mount on a wall and hold a number of prepared heated beverages, and maintain their temperatures for many minutes, until the customer arrives to receive their beverage.

### BRIEF DESCRIPTION OF THE DRAWINGS

FIG. 1 is a right front side perspective view of a heated beverage dispenser embodying the principles of the present invention.

FIG. 2 is a top elevational view of the heated beverage dispenser of FIG. 1.

FIG. 3 is a front elevational view of the heated beverage dispenser of FIG. 1.

FIG. 4 is a right elevational view of the heated beverage dispenser of FIG. 1.

FIG. 5 is a right side sectional view of the heated beverage dispenser of FIG. 1.

FIG. 6 is a front sectional view of the heated beverage dispenser of FIG. 1.

FIG. 7 is a left front side perspective view of the heated beverage dispenser of FIG. 1 with beverages loaded in the dispenser.

FIG. 8 is an electrical schematic of the electrical components of the heated beverage dispenser of FIG. 1

FIG. 9 is a right side sectional view of a further embodiment of the heated beverage dispenser embodying the principles of the present invention.

### DETAILED DESCRIPTION OF THE PREFERRED EMBODIMENTS

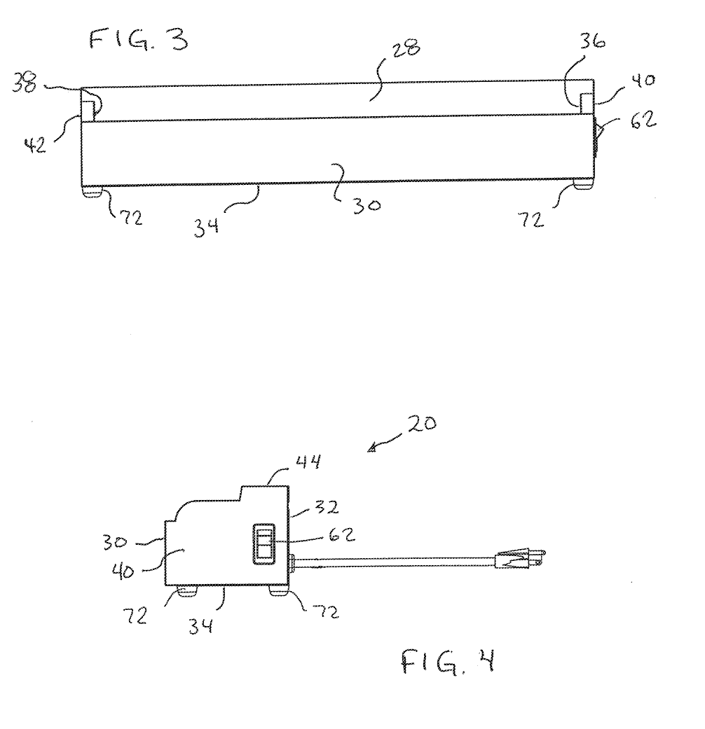

An embodiment of the invention is illustrated in the FIGs., although the present invention can take the form of other embodiments which may vary from the one illustrated. In FIGS. 1-7, a rail 20 for heated beverages is illustrated in which a single row of heated beverages can be held at an elevated temperature for dispensing cupped heated beverages to customers, as needed.

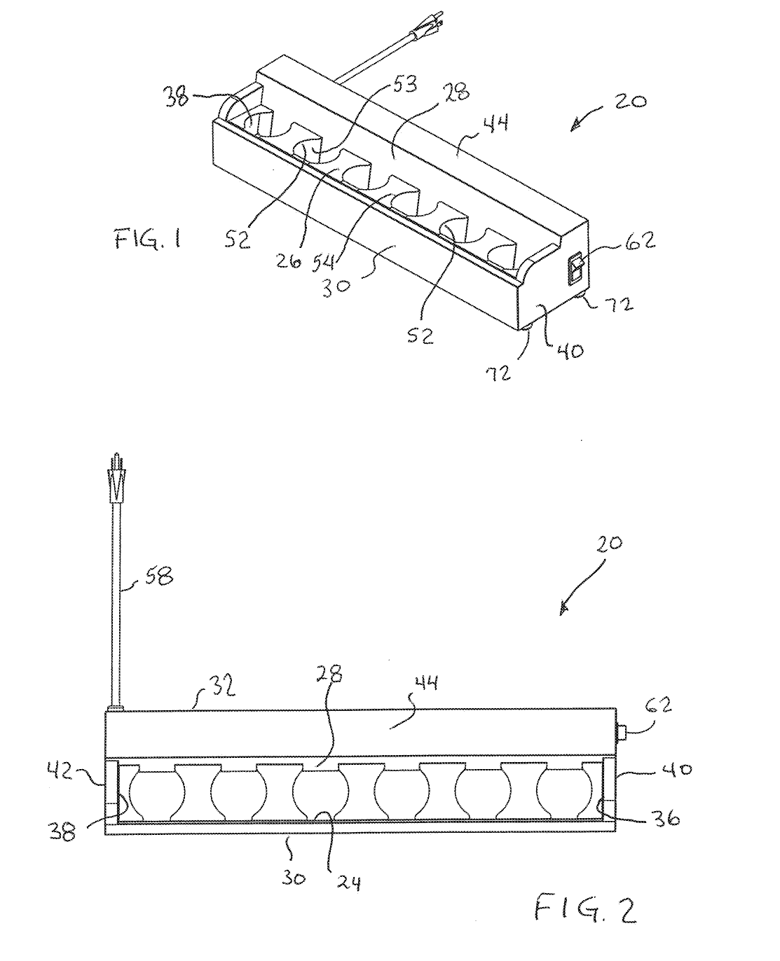

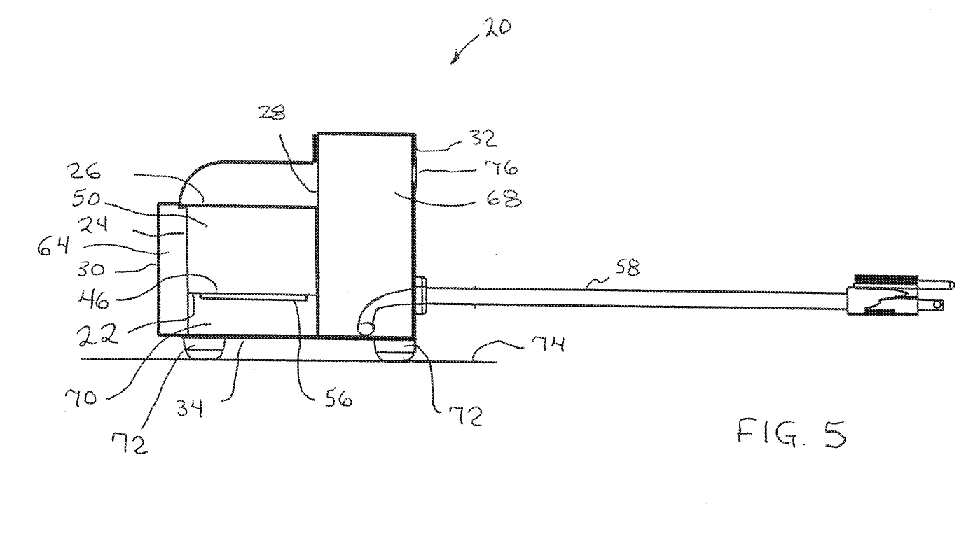

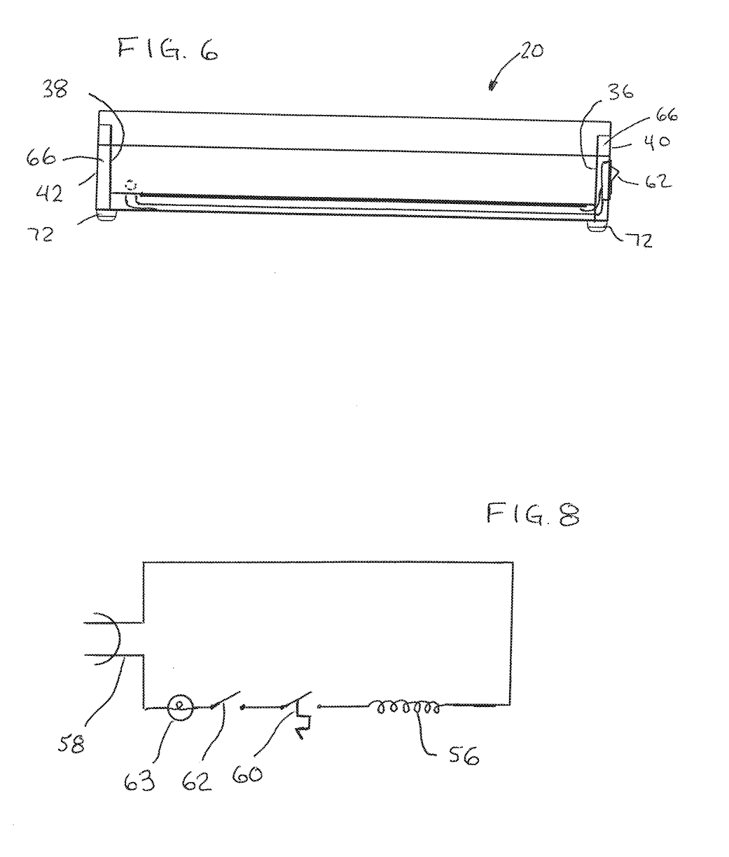

The rail 20, as illustrated in FIG. 5, is shown in cross section as having a shelf 22, a front wall 24, a top wall cup bracket 26, a rear wall 28, an outer front wall 30, an outer rear wall 32 and a bottom wall 34. FIGS. 1-3 illustrate a right-side wall 36, and an additional similar left-side wall 38 is located on an end of the dispenser opposite from the right side wall 36. An outer right side wall 40 and an outer left side wall 42 are also provided. Further, FIGS. 1 and 2 show a top ledge 44 connecting a top edge of the rear wall 28 and the outer rear wall 32.

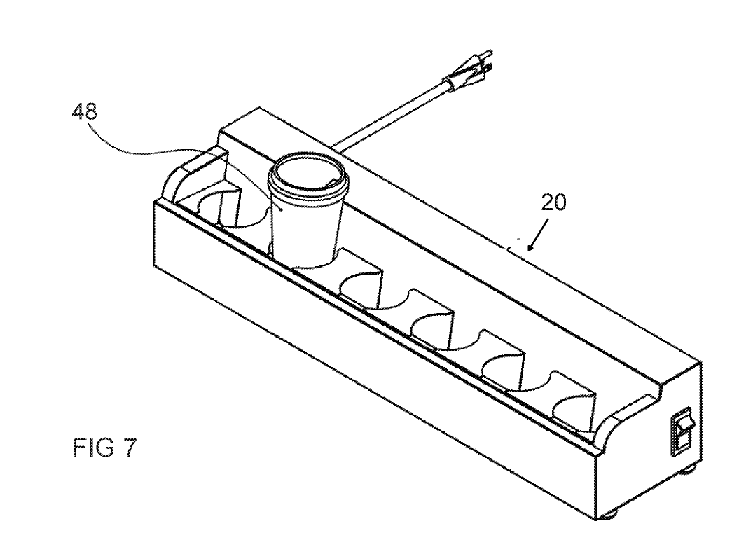

The shelf 22 comprises a horizontal surface 46 for contacting and supporting at least one beverage container 48 (FIG. 7) such as a beverage cup. The front wall 24 extends vertically above the shelf 22. The rear wall 28 extends vertically above the shelf 22. The pair of side walls 36, 38 extend vertically above the shelf 28. The top wall cup bracket 26 extends from a top edge of the front wall 24 substantially parallel to the shelf 28 and defines a space 50 within the dispenser 20 bounded by the top wall 26, front wall 24, rear wall 28 and side walls 36, 38.

At least one opening 52 is provided in the top wall cup bracket 26 sized to receive the beverage container or cup 48. Preferably, a plurality of such openings 52 are provided in the top wall cup bracket 26, spaced laterally from each other a sufficient distance to permit a server or customer ample room in which to grasp a cup 48 without their hand engaging with an adjacent cup. While the figures show six openings 52 positioned side-by-side for receiving six beverages, a larger or smaller number of openings may be provided in the top wall cup bracket 26 for receiving more or fewer beverages. The openings 52 may also be in the form of spaces between adjacent top wall cup bracket segments, with the segments supported on the outer front wall 30 and having a depending leg 53 (FIG. 1) which may be attached to the rear wall 28, by adhesives or tack welding or other known attachment arrangements.

The top wall cup bracket 26 is spaced above the shelf 22 by a distance in the range of A-B inches to provide an ample sized heated space 50 and to allow side edges 54 of the openings 52 to provide lateral support for the beverage cups 48, along a sufficiently large height of the cups 48, so as to prevent them from tipping. Beverage cups are commercially available in four standard sizes, measured by liquid volume, 8 oz/12 oz/16 oz/20 oz with heights of 3.5 to 6 inches and mid-height diameters ranging from 2.25 to 3 inches, in a slightly downwardly tapered form. The openings 52 in the top wall 26 are generally circular, with a diameter in the range of 2.5-3.5 inches. This opening size allows for accommodation of all standard sized cups to be easily received in the opening 52, and for the cups to be easily inserted and removed by a server or customer. The openings 52 may be shaped other than circular, and may also include shapes having portions of a circle, and portions which are cords across the circle, as shown in FIG. 2. By providing the top wall cup bracket 26 spaced a distance of 1.5 to 3 inches above the shelf 22, a range of 2 to 4.5 inches of the cups 48 are exposed above the top wall, allowing ample gripping surface for a server or customer to grasp the cups to place them in the rail 20 and to remove them from the rail.

An electrical heating unit 56 (FIG. 5) is powered by a power line 58, which can be connected to a wall socket of a power supply. The heating unit 56 is arranged within the rail 20 to heat the space 50 (and/or the shelf 22). The electrical heating unit 56 may be in the form of a resistance heater, and can be provided, for example, as a relatively thin sheet attached to an underside of the shelf 22, such that the shelf and the space 50 above it will be heated. The electrical heating unit 56 is preferably sized so as to increase the temperature within the space 50 to a temperature of no more than about 100 to 185 degrees F., so that, although elevated above ambient temperature, which is typically in the range of 60-80 degrees F., the temperature within the space 50, and consequently the walls 24, 26, 28, 36 and 38 surrounding the space, is not elevated to a level that would cause burning of skin upon contact with those surfaces or spaces for less than 30 seconds. Nevertheless, such a temperature in the space 50 will maintain the increased temperature in the heated beverage container 48 within one or two degrees F. for up to 15 minutes.

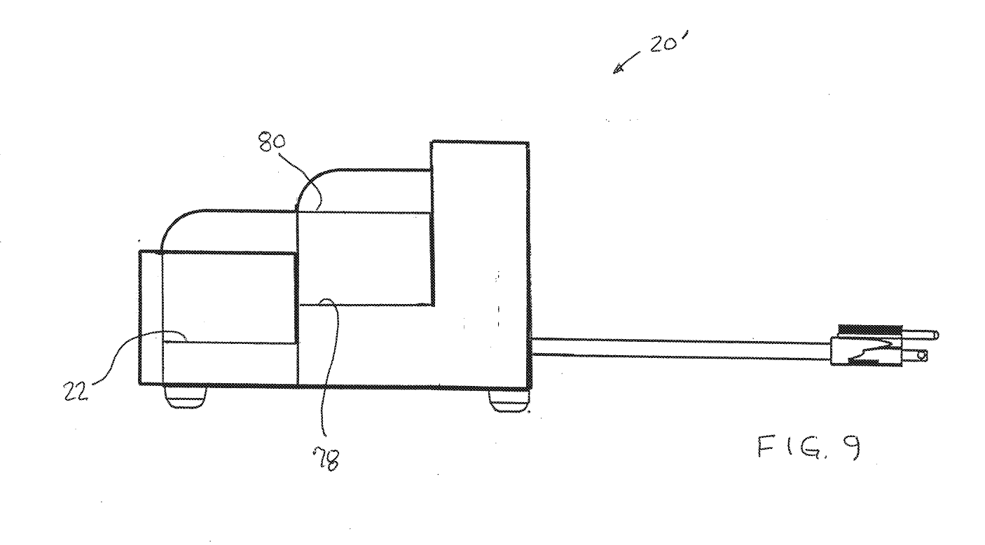

As seen in FIG. 8, a thermostat 60 is provided in line with the heating unit 56 and is configured to control a temperature of the shelf 22 and/or the space 50. The thermostat 60 may be adjustable so that varying temperatures within a set range may be selected by an authorized user, and the thermostat may be located within the interior of the dispenser 20 so that settings of the thermostat cannot be changed without dismantling a portion of the dispenser.

An on/off switch 62 is arranged in the power line 58 leading to the heating unit 56, and in series with the thermostat 60, to allow a user to selectively energize or deenergize the heating unit. For example, the switch 62 may be located on one of the outer side walls 40, 42, or on the outer rear wall 32 or on the ledge 44. The switch may be lighted, or a separate light 63 may be associated with the switch to provide an additional indication, other than the position of the switch, that the heating unit 56 is energized.

As seen in FIG. 5, the outer front wall 30 is spaced from the front wall 24, to provide a thermal buffer space 64, thereby resulting in an unheated outer front wall for the dispenser 20. Similarly, as shown in FIG. 6, the pair of outer side walls 40, 42 are spaced from the pair of side walls 36, 38, to provide a thermal buffer space 66 between the side walls and the outer side walls, thereby resulting in substantially unheated outer side walls for the dispenser 20.

The outer rear wall 32 is spaced from the rear wall 34, as seen in FIG. 5, to provide a thermal buffer space 68 between the rear wall and the outer rear wall, thereby resulting in a substantially unheated rear wall for the rail 20. This space 68 can also accommodate the power line 58 and the switch 62, and other electrical components, as needed.

The ledge 44 extends between a top of the rear wall 28 and a top of the outer rear wall 32 and is spaced sufficiently far from the heated space 50 so as to remain substantially unheated.

The bottom wall 34 is spaced below the shelf 22, to provide a thermal buffer space 70 between the shelf and the bottom wall, thereby resulting in a substantially unheated bottom wall for the rail 20. The thermal buffer space 70 below the shelf 22 also provides space for the heating unit 56 between the bottom wall 34 and the shelf, and which may be pressed directly against the underside of the shelf.

An underside of the bottom wall 34 may be provided with a plurality of feet 72 which will serve to elevate the bottom wall above a supporting surface 74, and to minimize any heat transfer to the supporting surface. The feet should be spaced sufficiently far apart from each other so as to provide stability for the dispenser 20 such that it will not tip over when loaded with beverage cups 48.

The outer rear wall 32 may be provided with at least one mounting receptacle 76, which may be in the form of holes, such as keyhole shaped holes, or tabs designed to engage with supporting structures mounted on adjacent vertical walls.

In another embodiment, as shown schematically in FIG. 9, the dispenser 20′ may be provided with at least one additional horizontal shelf 78 with a cup contacting surface positioned to the rear of the first shelf 22, and elevated above a level of the first shelf. In such an embodiment, a further top wall 80 with openings therein would also be provided in order to have the rail 20′ able to hold more than one row of cups for service.

Although certain embodiments of the invention have been shown and described, a heated rail incorporating the principles may be configured differently than shown or described. For example, the number of openings 52 for receiving beverage containers 48 may be larger or smaller than shown in the drawings, and the number of different shelves may be larger than shown in the drawings. A single heating unit 56 heating a single zone has been shown, although multiple heating units and multiple heated zones may be provided, each having either a common or separate power switches and thermostats. The entire rail 20 may be formed from metal, or portions of the rail may be formed of other materials, including plastics and composite materials. Preferably at least the shelf 22 is formed of metal to transmit the heat, if the heating unit 56 is located under the shelf. The heating unit 56 may be positioned within the heated space 50, in which case, the shelf may also be made of plastic or composite materials.

In the North American market, the heating unit 56 may be rated in the range of 100-10000 W, 110-120 V. In other markets where 220-240 V is a more prevalent power supply, the heating unit 56 may operate at those voltages.

The disclosed dispenser 20, 20′ has a low profile and small footprint, and can easily fit on a counter or mount on a wall and hold a number of prepared heated beverages, and maintain their temperatures for many minutes, until the customer arrives to receive their prepared heated beverage.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A heated beverage rail comprising:
a shelf comprising a horizontal cup contact surface for receiving at least one beverage container;
a front wall extending vertically above the shelf,
a rear wall extending vertically above the shelf,
a pair of side walls extending vertically above the shelf,
a top wall cup bracket extending from a top edge of the front wall substantially parallel to the shelf and defining a space within the dispenser bounded by the top wall, front wall, rear wall and side walls,
at least one opening in the top wall cup bracket sized to receive a heated beverage cup,
an electrical heating unit arranged within the rail to heat the cup contact surface, and
a thermostat in line with the heating unit configured to control a temperature of the cup contact surface.

2. The heated beverage rail according to claim 1, and further including an outer front wall spaced from the front wall, to provide an unheated front wall for the dispenser.

3. The heated beverage rail according to claim 1, and further including a pair of outer side walls spaced from the pair of side walls, to provide unheated side walls for the rail.

4. The heated beverage rail according to claim 1, and further including an on/off switch in line with the heating unit to allow a user to selectively energize the heating unit.

5. The heated beverage rail according to claim 1 wherein the top wall cup bracket has a plurality of openings therein to receive a plurality of heated beverage cups simultaneously.

6. The heated beverage rail according to claim 1, and further including an outer rear wall spaced from the rear wall, to provide an unheated rear wall for the dispenser.

7. The heated beverage rail according to claim 6, further including a ledge extending between a top of the rear wall and a top of the outer rear wall.

8. The heated beverage rail according to claim 1, wherein said top wall is spaced above the shelf by a distance in the range of 1.5 to 3 inches.

9. The heated beverage rail according to claim 1, wherein the opening in the top wall is generally circular, with a diameter in the range of 2-4 inches.

10. The heated beverage rail according to claim 1, further including a bottom wall spaced below the shelf.

11. The heated beverage rail according to claim 10, wherein the heating unit is located between the bottom wall and the shelf.

12. The heated beverage rail according to claim 10, further including at least one additional horizontal shelf with a cup contact surface positioned to the rear of the shelf, and elevated above a level of the shelf.

13. The heated beverage rail according to claim 1, further including a plurality of feet positioned below the shelf to elevate the beverage dispenser above a supporting surface.

14. The heated beverage rail according to claim 6, further including at least one mounting receptacle arranged in the outer rear wall.
